(19) United States
(12) Patent Application Publication
(10) Pub. No.: US 2022/0019575 A1
(43) Pub. Date: Jan. 20, 2022

(54) System And Method For Augmenting Database Applications With Blockchain Technology

(71) Applicant: ZeU Technologies, Inc., Montreal (CA)

(72) Inventor: Yuming QIAN, Richmond Hill (CA)

(73) Assignee: ZeU Technologies, Inc., Montreal, QC (CA)

(21) Appl. No.: 17/299,736

(22) PCT Filed: Nov. 28, 2019
(86) PCT No.: PCT/CA2019/051700

§ 371 Date: Jun. 3, 2021

Related U.S. Application Data
(60) Provisional application No. 62/775,201, filed on Dec. 4, 2018.

(51) Int. Cl. G06F 16/23

(52) U.S. Cl. CPC G06F 16/2379

(57) ABSTRACT

A method for augmenting a database application with blockchain technology is disclosed. The method involves recording data modifications made by a database application into a corresponding database as well as on a blockchain for global consensus confirmation. This is done without changing the existing application architecture and with minimal code changes to the existing application. Records in the database requiring synchronization with the blockchain are subjected to consensuses voting, and unauthorized database changes are rolled back, thereby granting immutability and non-repudiation characteristics to a traditional database application. Records in databases are thus made globally consistent. An existing database application can be deployed on a blockchain without significantly modifying the code. Multiple applications can synchronize data through a common blockchain, which greatly simplifies building blockchain applications.

### TECHNICAL FIELD

The present application relates generally to a blockchain system, and in particular to augmenting database applications with blockchain technology.

### BACKGROUND ART

Enterprise applications have traditionally used a tiered or layered architecture, typically made up of a presentation layer, a business layer and a data storage or persistence layer. The presentation layer includes software components that provide the user interface to facilitate user interaction. The business logic layer contains software components that implement the business rules or business logic that are applied to data. The storage layer contains software components used for storing persistent data and provision of related data access services.

Although considerable variations exist in the mix of components and services in each of the layers, the data storage layer typically includes a relational database management system (RDBMS) or a NOSQL database to implement the data storage service.

Relational database management systems that are suitable for enterprise class applications typically support transactions that should guarantee validity, even in the event of errors. Transactions are individual, indivisible operations that may occur concurrently. A transaction processing system manages concurrent processing of transactions, enables the sharing of data, ensures the integrity of data and manages the prioritization of transaction execution.

Database transactions are thus characterized by a set of properties called atomicity, consistency, isolation, and durability (ACID for short). Atomicity means that all changes to data are performed as if they are a single operation. Consistency requires that data is in a consistent state when a transaction starts and when it ends. Isolation means that the intermediate state of a transaction is invisible to other transactions. Durability implies that after a transaction successfully completes, changes to data persist and are not undone, even in the event of a system failure.

It is often a basic requirement in database applications is that in database transactions, where one operation involves multiple database operations and these records must be all succeed or fail together. For example, a transfer of funds from one bank account to another, even involving multiple changes such as debiting one account and crediting another, is a single database transaction.

Blockchain transactions on the other hand work via consensus. Blockchain technology maintains a reliable record of transactions by means of collective participation and consensus among participants. Blockchain has often been understood and described as a distributed ledger technology (DLT), jointly maintained by multiple networked devices called nodes. Blockchain can thus be thought of as a distributed database system.

When traditional enterprise applications migrate to the blockchain, the characteristics of related database transaction operations need to be preserved.

Conventional enterprise applications that wanted to use blockchain technology replaced code in the business logic layer interfacing with the storage layer, with new relevant business logic code suitable for the characteristics of the blockchain used. Not surprisingly, this was a costly, time-consuming and laborious exercise. The difficultly created a barrier for migrating traditional database applications to the blockchain domain.

Another challenge preventing conventional database applications from adopting blockchain technology is blockchain transaction completion performance. In a blockchain, a consensus mechanism exists by which each blockchain transaction needs to wait for most of the nodes to confirm the transaction before writing the transaction into a block in the chain. A blockchain transaction thus often lasts for a few seconds or even minutes before it can be finally committed. In database applications on the other hand, the data writing operation committing a database transaction, is often instantaneous and as a result a general trading database system has response times that are measured in milliseconds.

Accordingly, there is a need for improved systems and methods to mitigate at least some of the aforementioned problems.

### SUMMARY OF INVENTION

In accordance with one aspect of the present invention there is provided a method of processing a transaction simultaneously in a database and a blockchain. The method includes modifying a first table the database in accordance with the transaction, and composing and inserting into the blockchain, a data operation record corresponding to the transaction, for consensus voting. The method further includes, upon a successful result from the consensus voting, committing the transaction by modifying a second table in the database corresponding to the transaction and otherwise rolling back the transaction thereby leaving the second table unchanged.

In accordance with another aspect of the present invention there is provided a method of synchronizing transactions in a database transactions with transactions in a blockchain. The method includes receiving a write command, in response to receiving the write command writing to a temporary working table; and submitting a corresponding write request to the blockchain for consensus voting. The method further includes upon receiving a result of the consensus voting, modifying the query table in accordance with the write command but otherwise leaving the query table unchanged.

In accordance with yet another aspect of the present invention there is provided a system for synchronizing a database and a blockchain. The system includes a processor executing instructions stored in memory so that, upon receiving a write request having data to be written to the database being received from an application, the processor performs the following steps of: writing the data into a working table in the database; submitting a data operation record to the blockchain for consensus voting; and writing the data into a query table in the database upon receiving indication of a successful result for the consensus voting, and otherwise leaving the query table unchanged.

In accordance with yet another aspect of the present invention there is provided a system for augmenting an application using a database with consensus voting in a blockchain. The application runs on a node on the blockchain. The system includes a database proxy receiving application commands from the application and translating them into database commands; a set of temporary tables in the database for storing local transactions before the blockchain completes the consensus voting; a set of query tables for recording data after the blockchain returns result of the consensus voting; a database log tracking module to track the changes in the database; a blockchain writer module to write data to the blockchain; and a blockchain listener module to monitor events and changes in the blockchain. The blockchain listener module and the blockchain writer module are in communication with the blockchain. The database proxy is in communication with the application and the database. The blockchain listener module is in communication with the database.

### BRIEF DESCRIPTION OF DRAWINGS

In the figures, which illustrate by way of example only, embodiments of the present invention,

FIG. 1 is a simplified schematic diagram of a system, exemplary of an embodiment of the present invention;

FIG. 2 is simplified schematic diagram of a working table in the database of FIG. 1,

FIG. 3 is simplified schematic diagram of a query table in the database of FIG. 1,

FIG. 4 is a flowchart of activities undertaken by a device executing application of FIG. 1;

FIG. 5 is a flowchart of an exemplary process for executing a transaction utilizing the device executing application of FIG. 1;

FIG. 6 is a flowchart of an exemplary process to recover and synchronize the database data after a new block is added to the blockchain of FIG. 1; and

FIG. 7 is a flowchart summarizing the steps for migrating an database existing application into an application that interacts with both its database and a blockchain.

### DESCRIPTION OF EMBODIMENTS

Embodiments of the present invention address issues related to migrating database applications to blockchain applications. These issues include the migration of synchronous trading operations to asynchronous trading operations. This mismatch among the primary reasons that necessitate business layer code to be rewritten.

A key advantage of blockchain technology is to ensure tamper-evident transactions, but the architecture and design of the blockchain is predetermined. For blockchain applications, only incremental operations could be implemented. Blockchains are not suitable for random queries or random condition modification. In fact, making random modifications difficult, if not impossible, is a desirable property of blockchains which aim to ensure immutable audit trail without a trusted intermediary institution. Unfortunately, this property also restricts the flexibility and scope of application development.

A blockchain application does not need to save all the data into the blockchain. Rather only some of the non-repudiation of the stored data needs to be saved into the blockchain. Thus most blockchain applications are still dependent on relational databases, to store a variety of local information. For example, user login authentication is likely to still be done on a traditional relational database management system or NOSQL database which makes synchronization of the database and blockchain.

A description of various embodiments of the present invention is provided below. In this disclosure, the use of the word “a” or “an” when used herein in conjunction with the term “comprising” may mean “one”, but it is also consistent with the meaning of “one or more”, “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like. Directional terms such as “top”, “bottom”, “upwards”, “downwards”, “vertically” and “laterally” are used for the purpose of providing relative reference only, and are not intended to suggest any limitations on how any article is to be positioned during use, or to be mounted in an assembly or relative to an environment.

The terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

A “blockchain” is a tamper-evident, shared digital ledger that records transactions in a public or private peer-to-peer network of computing devices. The ledger is maintained as a growing sequential chain of cryptographic hash-linked blocks.

A “node” is a device on a blockchain network. The device is typically be a computer having a processor interconnected to a processor readable medium including memory, having processor readable instructions thereon.

In addition, the terms “first”, “second”, “third” and the like are used for descriptive purposes only and cannot be interpreted as indicating or implying relative importance.

In the description of the invention, it should also be noted that the terms “mounted”, “linked” and “connected” should be interpreted in a broad sense unless explicitly defined and limited otherwise. For example, it could be fixed connection, or assembled connection, or integrally connected; either hard-wired or soft-wired; it may be directly connected or indirectly connected through an intermediary. For technical professionals, the specific meanings of the above terms in the invention may be understood in context.

In the drawings illustrating embodiments of the present invention, the same or similar reference labels correspond to the same or similar parts. In the description of the invention, it should be noted that the meaning of “a plurality of” means two or more unless otherwise specified; The directions or positions of the terms “up”, “down”, “left”, “right”, “inside”, “outside”, “front end”, “back end”, “head”, “tail”, the orientation or positional relationship shown in the drawings is merely for the convenience of describing the invention and simplifying the description rather than indicating or implying that the indicated device or element must have a particular orientation and be constructed and operated in a particular orientation, and therefore cannot be used as a limitation of the invention.

### Software System Architecture

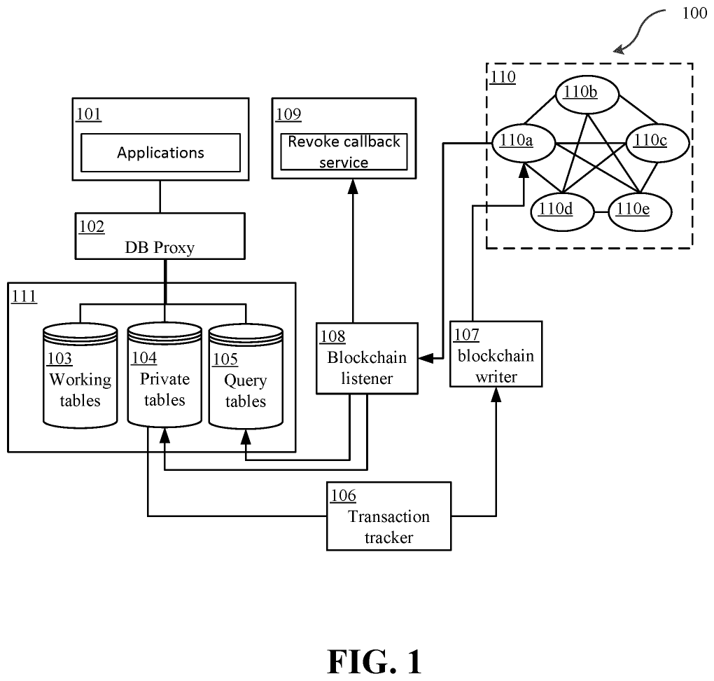

FIG. 1 depicts a schematic diagram of a software system 100, exemplary of an embodiment of the present invention. A client application 101 which is a software application, exchanges data with a database 111.

The database 111 is a relational database management system and includes a plurality of tables including the working tables 103, the private tables 104 and the query tables 105 that are accessible through a database proxy service 102.

A blockchain listener service 108 is in data communication with tables 104, tables 105 and a revoke callback service 109. A blockchain 110, made up of a plurality of nodes 110a to 110e interconnected together by a data network, implements consensus voting to process blockchain transactions which will be synchronized with application 101.

A transaction tracker component 106 in data communication with the private tables 104 tracks transactions. A blockchain writer component 107, in communication with blockchain 110, submits transactions to be voted on and upon consensus written into a block in the blockchain.

The client application 101 is a database application, i.e., a database driven software application. In a blockchain system such as system 100, different organizations perform different responsibilities, and thus each one of nodes 110a to 110e may run multiple applications. However, these different applications read from and write to a common information store.

Private tables 103 are local private tables which keep data locally. The data in tables 103 does not need to be synchronized to blockchain for consensus.

Query tables 105 contain persistent data stored in database 111, and may contain data suitable for use by applications such as application 101.

Working tables 104 are temporary tables that are created as copies of corresponding original tables that resemble the query tables, with additional status or state fields or columns appended to help manage potential transaction conflicts, and coordinate persisting data in to the database 111 with consensus voting in blockchain 110.

The database proxy service 102, in the depicted embodiment, is a proxy service for facilitating access to the database 111. The database proxy service 102 receives requests from application 101. After receiving a request from the application 101, the database proxy service 102 determines whether the request is a read request or a write request and translates the request into an appropriate structured query language (SQL) statement suitable for an RDBMS such as database 111. In alternate embodiments, the read or write requests may be translated into appropriate stored procedures or an application programming interface (API) calls using a predefined interface for low level data access for the particular database 111.

Read requests related to blockchain data are forwarded to the query tables 105 while write requests are forwarded to working tables 103. Local data read and write requests are forwarded to the private tables 104.

As the application 102 performs a data operation requiring synchronization with the blockchain 110, the related operation is first directed to the working tables 103 by the proxy service 102, and the transaction log is generated after the working tables 103 perform the transaction operation, which is monitored by the transaction tracker component 106.

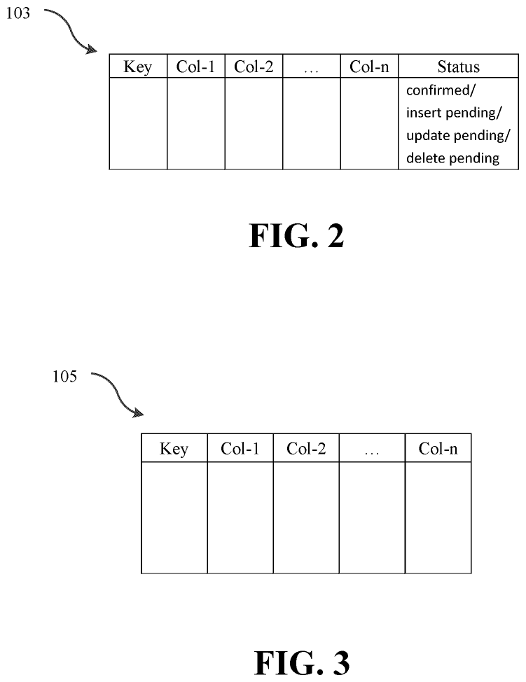

In this embodiment, all the tables in the working tables 103 have a “Status” column to record the current record status as illustrated in FIG. 2. Transaction state or status values for transactions that have yet to be confirmed by the blockchain 110 are said to be in a pending state or pending status, which includes status values “Pending insert”, “Pending update” and “Pending delete”. The status is changed to “Committed” after a consensus is successfully reached in the blockchain. If the blockchain consensus operation fails, the relevant records in working tables 103 and related local tables will be rolled back, and the status column will be marked as “Committed”.

Query tables 105, contain data that results from consensus voting in blockchain system 110. FIG. 3 schematically illustrates an example of a query table 105.

A blockchain write service component 107 writes the extracted data change record, into the blockchain 110 to initiate a consensus operation. In one embodiment, the write service component 107 reads the data change record filtered by the query tables 105, then calls a blockchain smart contract, initiates a write request to the blockchain 110, and writes the changed one or more data records to the blockchain 110. In other embodiments utilizing a different blockchain, component 107 may use different blockchain application programming interface (API) for writing data.

The content of the query tables 105 is recovered by blockchain writer module 107 from transaction logs recorded in blockchain system 110.

Transaction tracker component 106 is a log tracking component for monitoring logs generated by the database in real time and filtering the data change records of the private tables 104.

When a new block is generated and synchronized in blockchain 110, the blockchain listener service component 108 retrieves the block content, restores the data change log, converts to data change SQL statement and then plays back or executes the corresponding change operation in the query tables 105. If an operation conflicts with other operations which have already been initiated, the operation is discarded. If the current node identifier (node ID) is the same node ID in which change record is generated, the previous transaction information needs to be found in the log, and the original data will be restored in the worksheet or working tables 103. Meanwhile, rollback information is written back to the blockchain 110 to ensure data consistency.

Callback Service 109 generates a call back to application 101, whenever consensus voting in blockchain 110 is completed. If the transaction is generated through the current node, the blockchain listener module 108 generates a call back to application 101 and notifies the consensus result, both when it denotes success and failure.

As will be appreciated by a person of skill in the art, there are several ways to notify application 101 about events. One common method is through a pre-defined callback API which is defined in configuration files. The predefined API will be called when local node in blockchain 110 gets the result of consensus voting. Alternatively, a message queue (MQ) or a shared database event table may be used. The result will be sent to the MQ or shared event table, and application 101 checks the MQ or event table to get notification.

Operational log data is recorded on the blockchain system 110. The blockchain 110 is a bridge that connects all nodes 110a to 110e in different locations and performs consensus voting.

As may be appreciated, when multiple nodes 110a to 110e attempt to record the same transaction, since the system time at each node may not be synchronized, there may be no way to ascertain the order of transactions originating in different nodes.

In one embodiment, for the sake of simplicity, the order in which the blockchain 110 initiates consensus is used as a criterion for resolving blockchain transaction conflicts. Each block in the blockchain is already synchronized across all nodes. Data modification will be presented as transaction log in blockchain 110.

In this embodiment, there is a restriction that in a given block, one record could be modified by one node. If there are multiple transaction logs that one record had been modified by multiple nodes in same block, the only accepted transaction logs would be from the first node and remaining transactions from other nodes are rejected. Changes for other nodes are unseen until the playback of transactions in the block. The database playback will ignore the remaining transaction logs for the other nodes for same record, and those transactions will be marked as failed. After a blockchain transaction is successful, subsequent pending blockchain transactions affecting or modifying the same record are rejected and the corresponding database transaction rolled back at the node that initiated the subsequent transaction. Other nodes also reject subsequent co-pending transactions.

To record a business operation, application 101 converts the business operation into one or more database operations that form part of a database transaction. In this embodiment, the application 101 uses the database interface or proxy 102 for the database transaction.

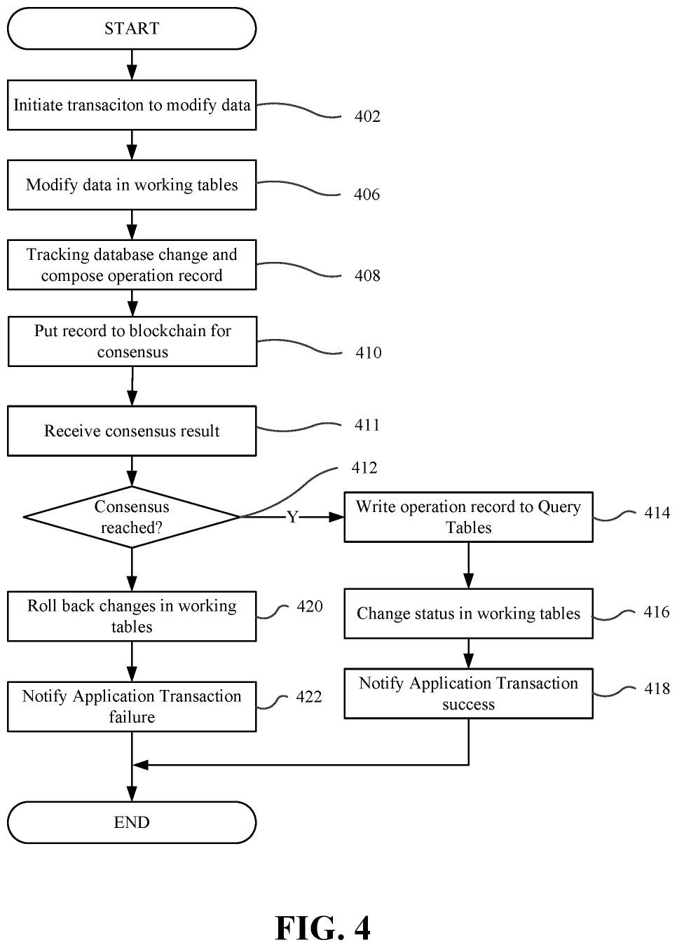

FIG. 4 depicts a flowchart of activities undertaken by a device executing application 101. In step 402, a database transaction is initiated. The underlying business operation may involve local database operations and blockchain operations that require consensus on the blockchain 110.

In step 406 the application 101 modifies the working tables 103. A consensus operation is required in the blockchain 110 before committing the transaction in the database 111.

In step 408, data tracking module 106 tracks the changes in database working tables 103 and composes an operation record. In step 410, a write data operation record is inserted into the blockchain 110 through the blockchain writer module 107 to perform consensus.

In step 411, after a period of time, the blockchain 110 completes the consensus, and a new block is generated and synchronized to the current node 110a. The application 101 receives the consensus result and determines whether each record successfully completed the consensus. If the consensus is successfully completed (step 412), then the operation record in the query table 105 (step 414) is used to restore the SQL statement, perform the database operation and resume the record.

In step 416, if the current node 110a is consistent with the data operation initiation node, the application 101 changes the record status in the working tables 103 and commits the transaction. In step 418, application 101 is notified by call back service 109 that the transaction has successfully completed the blockchain consensus. Otherwise application 101 copies the data in the query tables 105 to the corresponding working tables 103.

If the blockchain consensus fails (step 412), application 101 rolls back the database transaction and related records in database 111 are restored to the state before the transaction was initiated (step 420) and a notification is sent from call back service 109 that the transaction blockchain consensus failed (step 422).

Techniques for Synchronizing Blockchain Data with Database Data

The application 101 first accesses the local database 111. As update performance or speed of the blockchain 110 is much slower than the update speed of the database 111, in one embodiment, asynchronous update is used to ensure that the blockchain content is consistent with the database content.

As may be appreciated by persons of skill in the art, the two sets of tables in the database 111 are designed to handle data that needs to be synchronized with the blockchain 110. The first set of tables includes local temporary working tables 103 used to save data temporarily updated by the database. The second set includes query tables 105 that are used to restore data records from the blockchain 110 to the database. To avoid application complexity, a simple proxy, in the form of database proxy service 102, is provided between the application 101 and database 111 for read-write separation, mapping read requests to query tables, and write operations to temporary tables.

Working tables 103 are copies of original tables having one more status/state columns added or appended thereto. One of the added status column represents the transaction state the respective record or row. In one embodiment, this status column, e.g., the last column of working table 103 shown in FIG. 2, may have four status values. In other embodiments, a larger or fewer number of status values or state values may be employed.

In one embodiment, a status value of “Committed” means the data had finished consensus while a status value of “Insert pending” means the record is generated by an insert SQL command and is waiting for the consensus voting result. A status value of “Update pending” means the row or record is modified by an update SQL and is awaiting the result of consensus voting. A status value of “Delete pending” means the row is modified by a delete SQL, but not yet actually deleted and thus just marked for deletion while waiting for the consensus voting result.

The general format of a local transaction log is as follows:

Transaction ID | Table: Primary key: Data before modification: Modified
data: Operation | Table: Primary key: Data before modification: Modified
data: Operation | ... |

After the user of application 101 modifies the contents of the temporary table, the log monitor synchronizes the data modification log information and writes the log information to the blockchain 111.

The data structure and rules for writing to the blockchain 110 are as follows:

Blockchain data structure
{

| { | primary key: table name + KEY, |
|---|---|
| | Original value: the value before the data is modified, |
| | New value: the modified value of the data, |
| | Action: insert, update, delete, |
| | Operation node ID: the node where the operator is located |
| }, | |
| { | Primary key: table name + KEY, |

Original value: the value before the data is modified,
New value: the modified value of the data,
Action: insert, update, delete,
Operation node ID: the node where the operator is located

},
Transaction ID: This operation corresponds to the GTID of the
original library

}

If a local database transaction involves multiple records that need to be placed on blockchain 110, then there will be multiple data segments in the record.

When the local transaction succeeds, the node that completes the local transaction operation writes the relevant data to the blockchain 110 through a blockchain adapter having a smart contract. Normally blockchain 110 exposes an API for a client to access the smart contract. The adapter layer comprises smart contracts which can be invoked via the API to modify the blockchain data internally, and forms part of blockchain. Each node in blockchain 110 may include smart contract module (not shown). If local data fails to be synchronized to the blockchain 110 for any one of a variety of reasons, then after the local node is restored, the blockchain adapter automatically restarts sending the relevant logs to the blockchain 110 for consensus from the position last interrupted.

After the consensus is completed on the blockchain 110, the blockchain adaptation program monitors the blockchain changes and synchronizes the log data in the blockchain to the query tables according to the data recovery rules. When synchronizing data from the blockchain 110, if the data meets the requirements—that is, the original value matches the corresponding value in the query tables 105—then, the record can be restored into the query tables. For a local node, pending transaction data will be written to working table 103 before consensus but maintained in a pending status. After consensus is reached, the status or state in the working table 103 is changed to a confirmed status. The transaction is rolled back from working table 103 if consensus is not reached.

Otherwise it is determined whether the current node 110a is the transaction initiation node, and the transaction originator node will generate a new rollback record and write it into the blockchain. The transaction initiating node continues to determine whether the data in the working tables is a pending state that needs to be rolled back. If the status corresponding to the record is in a pending state, the current record is overwritten with its previous value and the status is set to “Committed”.

If a record has been modified in the working tables 103 but has not been confirmed by consensus voting on blockchain 110, the record would not be modified again until the result of the consensus voting related to the record is confirmed or rejected by the blockchain 110. A transaction attempting to modify a record in pending status will thus fail. In other words, a record having a pending status cannot participate in a new transaction.

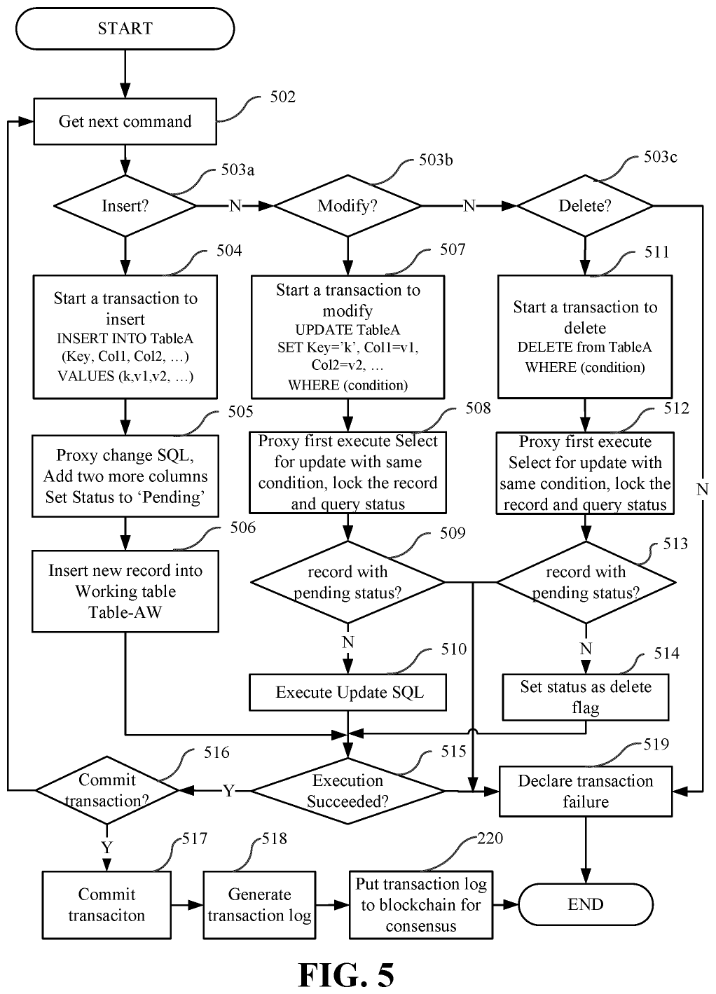

FIG. 5 is a flowchart of an exemplary process for executing a transaction. In step 501, application 101 initiates a data modification operation to start a database transaction, and the transaction will modify the data in the database. In step 502, the application 101 obtains the next execution statement in the transaction.

In steps 503a, 503b, and 503c it is determined whether the data operation involves inserting, updating or deleting a record respectively. Database proxy service 102 intercepts the application request, parses, and determines the applicable data operation and corresponding SQL statement.

In step 504, if the request is to insert new data, an insert operation is carried out and the corresponding table name is modified to working tables' name.

In step 505: a new insert statement is prepared by adding a state field or status field, to the content of the current record. There are four states: “pending insert”, “pending modify”, “pending delete” and “committed”. There states: “pending insert”, “pending modify”, “pending delete” are “pending” states or status values. The status field for new data being inserted is “pending insert”; the status field for “pending modify” after data is modified, and status field for a record being deleted in “pending delete”.

In step 506, a record is inserted into the corresponding working table.

In step 507, a record is updated in a working table using an SQL statement. The agent intercepts the SQL, and then modifies the corresponding working table.

In step 508: application 101 executes “select for update” on the work table 103 to lock the related records, so that other transactions cannot modify these records during the execution of the transaction; and to get the status field.

In step 509 it is determined whether the current record in a pending state or has a pending status. A record in a pending state cannot participate in another transaction as that will create a conflict. If there is a conflict between the current transaction and other transactions without the blockchain consensus, the current transaction cannot be executed and the transaction fails (step 519).

In step 510, the update SQL is executed. The data is updated to the working table 103, and the state of the record is modified to “pending update”. In step 511, the request statement is a delete statement, the proxy intercepts the SQL, and the modified corresponding table name is the working table name.

In step 512, a selection for update on the work table 103 is made to lock the related records, and get the state or status. Other transactions thus cannot modify the current record during the execution of the subject transaction. In step 513 it is determined whether the status field of result set has a pending status. If there is a conflict between the current transaction and other transactions without the blockchain consensus, the current transaction cannot be executed and fails (step 519).

In step 514, if there is no conflict record, the application 101 executes the update instruction, updates the status field in working table 103, and modifies the current state of all records involved in the transaction to “pending delete”. In step 515 the application checks if the current SQL is successfully executed, and if not, the transaction fails. In step 516 the application 101 determines whether to commit the transaction. If there are other transaction commands in the transaction, application 101 returns to step 502 to continue executing the remaining transaction commands.

In step 517, the transaction is committed and in step 518 a transaction execution log is generated at the database node or other database log synchronization node, and the node identifier is recorded. In step 519 a transaction failure is declared and an equivalent message is sent to the application 101. In step 520, the transaction execution log is formatted in a suitable format. In one embodiment, the format may be a Java Script Object Notation (JSON) record. The record is then written to the blockchain through the blockchain interface to start consensus.

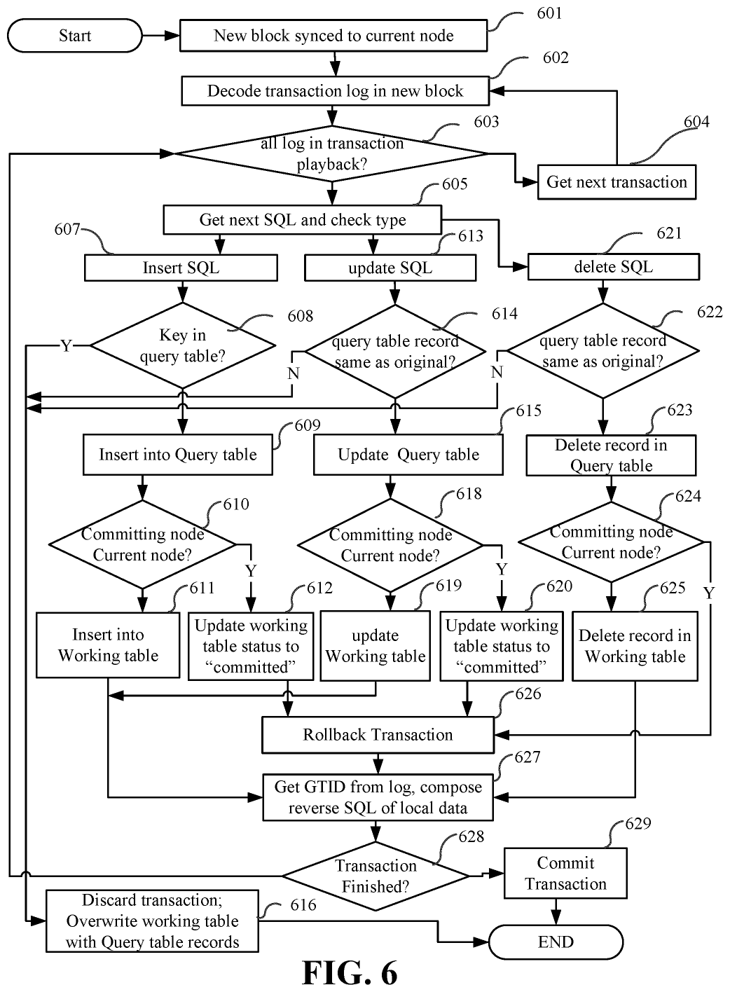

After a new block is generated in the blockchain and synchronized to a node. Blockchain data is synchronized using a process to recover and synchronize the database data as summarized in FIG. 6.

In step 601, a new block is generated in the blockchain and synchronized to the current node. In step 602, transaction log list from the current new block is decoded. In step 603 a check is made as to whether there is a record of the uncompleted playback of the transaction log list. The transaction log list includes of multiple transactions, and each involves one or more records. Only records that require consensus records that need to be synchronized with other nodes, the local data is not placed on the chain. When the transaction has a record that has not been completed, it continues to convert the record to SQL for playback in the database. If the transaction has completed execution, the commit action is performed in the database. If there are other transactions to be executed, continue to get the next transaction and execute.

In step 604 the next transaction record is obtained from the transaction log by order. In step 605 the next record is obtained in the transaction. The record is restored to the SQL operation in accordance with its data content. The data content includes the original value, the changed new value, the type of operation and operation node information. In step 606 the operation type of the data record is checked. The type is one of: insert, update or delete requiring a corresponding method for data recovery.

In step 607 an insert statement is constructed. In step 608, the query table 105 is inspected to see if the primary key corresponding to the insertion statement already exists. If the key already exists, it indicates that the transaction may conflict with other transactions in the same block. In other words, other applications on a certain blockchain node have already started an insert operation using the same key, which will be performed first, and will lead to a second insert operation for the same record to fail. Recall that a primary key uniquely identifies a record in a table in RDBMS.

In step 609 an insert operation into the query table. At this stage, it is already known that a record does not exist in the query table having the same key (at step 607). In step 610 it is determined whether the generated node of the log is the current node. If it is the current node, it indicates that there is a corresponding operation record in the working tables, which needs further processing. In step 611 record is directly inserted into the working table. It has already been determined that the log generation node is not the current node (in step 610). If the working table has the same data as the primary key, the current node performs a conflict operation after the other node performs the recording operation, and directly discards it. Record in the working table and use the query table record to overwrite and change the status to “committed”.

In step 612 the corresponding record in the working tables is located, and the status changed to “committed”. It is necessary to confirm that the recorded content in the working tables is consistent with the current record, and if the records are inconsistent, the current record wins and is taken as the correct value.

In step 613, an update statement (e.g. SQL) is prepared and in step 614, it is compared whether there is a record of the same primary key in the query tables. If the primary key is not found, there may be another deletion transaction affecting the record that conflicts with current operation, the corresponding record is deleted before the current record executed, and the update record cannot continue to execute, the current transaction will fail, which leads to roll back of all associated steps.

In step 615, the record of having the primary key in query tables is updated and replaced with the new value. In step 616, the transaction is discarded and original values in working tables are restored into query tables.

In step 618 it is checked if the current node and the record update node are the same node. If not, in step 619, the query tables data is copied to the working tables. Otherwise, in step 620 as differing values indicating pending transactions submitted to the blockchain, the working tables are simply overwritten. The new modification of the application in the working tables is notified to be discarded. The working tables 103 state is set to Committed.

In step 621 the deletion process is executed. In step 622 it is checked if there a record in the query tables that has the same primary key to be deleted and if not, in step 623 the record is deleted from the corresponding record in the query tables.

In step 624: Is the current node the same as the data submission node? If the same description of the working tables has the same record, it is necessary to additionally determine whether the pending transaction in the working tables 103 conflicts with the current transaction. If the original value is different, the conflict is confirmed, and the pending transaction in the working tables 103 is discarded and the application is notified.

In step 625 the record corresponding to the primary key is deleted from the working tables 103. In step 626 the transaction is rolled back. If working tables 103 related transaction operation involves other local data operations, the working tables 103 local transaction log needs to be queried. In step 627 a reverse operation is built according to the transaction log, to roll back other operations in the same transaction in other data tables.

In step 628 it is checked if the current transaction ends, and if so in step 629, the transaction is committed; otherwise the process continues to acquire the next transaction in the blockchain until all operations in the block are processed.

If the data modification operation is an insert statement, then the insert operation is performed on the working tables 103.

The data format for generating a synchronization event to the blockchain is as follows:

{

{ primary key: table name + KEY,

Original value: empty,
New value: a list of inserted key values,
Action: Insert,
Operation node ID: the node where the operator is located

},
transaction ID: This operation corresponds to the GTID of the
original library

}

After the consensus is successful, according to the record, a forward data insertion SQL statement can be generated.

Insert into [table name] values (list of values)

If the consensus fails, you can generate a reverse rollback statement to roll back the work related operations based on the transaction log, which contains all of the values prior to commencing the transaction.

Delete from [table name] where key=[primary key]

If the data modification operation is an update statement, the worksheet or working table performs a data update operation. The data format for generating synchronization to the blockchain is as follows:

{

{

Primary key: table name + KEY,
Original value: key1: val1_0, key2: val2_0 ...
New value: key1:val1, key2:val2 ...
Operation: insert,
Operation node ID: the node where the operator is located

}
, transaction ID: This operation corresponds to the GTID of the original
library
}

After the consensus is successful, according to the record, a forward data update SQL statement can be generated.

Update [table name] set key1=val1,key2=val2 . . . .

At the same time, the update operation is also performed on the worksheet.

Update [table name] set status=‘committed’ where key1=val1

If the consensus fails, you can generate a reverse rollback statement to roll back the work related operations

Update [table name] set key1=val1_0, key2=val2_0 . . . .

If the data modification operation is delete statement, the work table performs a data update operation, and the original data state is changed from “committed” to “pending delete”.

The data format for generating synchronization to the blockchain is as follows:

{

{

primary key: table name + KEY,
Primary key: key1
Original value: key1:val1_0,key2:val2_0....
New value: null
Operation: delete,
Operation node ID: the node where the operator is located

},
transaction ID: This operation corresponds to the GTID of the
original library

}

After the consensus is successful, according to the record, a forward data deletion SQL statement can be generated.

Delete from [table name] where primarykey=val1_0

Also perform a delete operation on the worksheet.

If the consensus fails, you can generate a reverse rollback statement to roll back the work related operations

Update [table name] set status=committed where primarykey=val1_0

### Application Migration

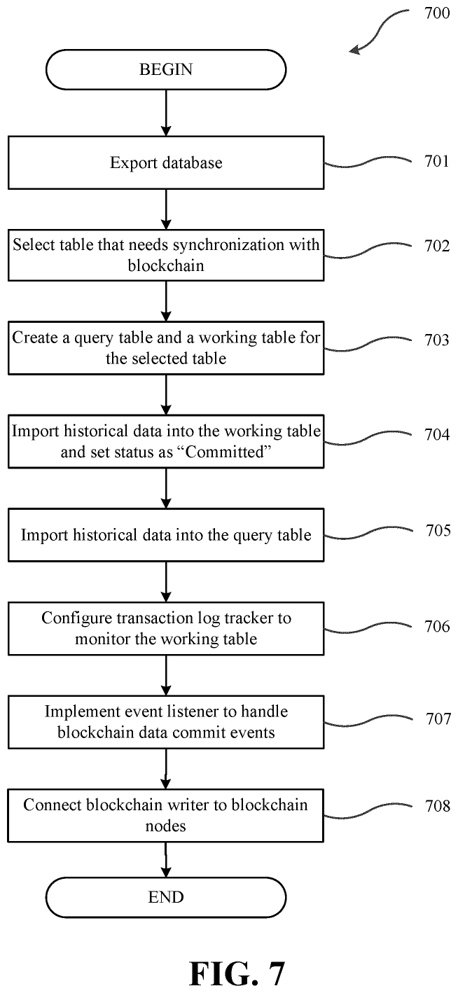

FIG. 7 depicts a flowchart summarizing the steps for migrating a database existing application into an application that interacts with both its database and a blockchain.

In step 701, the original database structures and data are exported.

In step 702, tables that need synchronization with the blockchain or consensus voting are selected.

In step 703, two tables are created for each original table that needs consensus voting or synchronization with blockchain. One table is a work table for which a field or column for status or state is added, in addition to the exported data structure of the original table. Another table is a query table, which is structurally completely consistent with the data structure of the original table.

In step 704: exported historical data is imported into the worksheet, and set the content of the status or state field is set to “Committed”.

In step 705: the exported historical data is imported into the query table.

In step 706: a transaction tracking module is configured to track transaction change information of the worksheet.

In step 707, at the application layer, the transaction consensus event processing code is written. When the blockchain is successful for the transaction operation, the application layer consensus result is notified by the message mode, and the application layer determines the subsequent processing mode according to the business logic.

In step 708, for a different new blockchain, a blockchain adaptation code is written. The adaptation code mainly includes code to write the event to the new blockchain, and code to listen to the new blockchain's data change operation and to process the change.

One of the greatest technical challenges to utilizing blockchain technology in database applications is architecture incompatibility. Database applications and in some cases, even business processes need to be adapted to the characteristics of blockchain.

Embodiments of the present invention lead to the development or modification of applications so that the applications can seamlessly choose certain critical data to be placed on a blockchain for data consensus while keeping others part of the data private. Advantageously, augmenting existing applications with this capability does not require substantial modification of the code. At the same time data consistency can be ensured. At least some of the embodiments described above allow an application to be directly extended from a single data center application to a globally distributed application, taking advantage of the blockchain technology while at the same time and avoiding the complexity of the blockchain. Embodiments of the present invention simplify application development and deployment for certain class of applications, and may further speed up the time to market.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A method of processing a transaction simultaneously in a database and a blockchain, comprising:
a) modifying a first table the database in accordance with the transaction;
b) composing and inserting into the blockchain, a data operation record corresponding to the transaction, for consensus voting;
c) upon a successful result from the consensus voting, committing the transaction by modifying a second table in the database corresponding to the transaction; and otherwise rolling back the transaction thereby leaving the second table unchanged; and
upon a new block being synced into the blockchain,
using a blockchain listener service component to retrieve a data change log from content of the new block;
converting the data change log to a corresponding database change command; and
executing the database change command in the database.

2. The method of claim 1, wherein said modifying said first table comprises setting a status column to one of a set of predetermined values.

3. The method of claim 2, wherein the set of predetermined values comprise “confirmed”, insert pending”, “update pending” and “delete pending”.

4. The method of claim 2, wherein said modifying the first table comprises one of: inserting, updating or deleting, a first record in the first table and wherein said modifying the second table comprises one of: inserting, updating or deleting a second record in the second table respectively.

5. The method of claim 4, wherein fields of the first record comprise all fields of the second record, and the first record further includes a status field corresponding to said status column.

6. The method of claim 1, further comprising, after said modifying, identifying a change in the database from a log of the database, wherein the change requires consensus voting by the blockchain.

7. The method of claim 1, wherein said modifying the first table is initiated by an application exchanging data with the database.

8. The method of claim 7, further comprising:
upon committing the transaction, notifying said application of transaction success; and
otherwise upon rolling back the transaction notifying said application of transaction failure.

9. A method of synchronizing transactions in a database transactions with transactions in a blockchain, the method comprising:
a) receiving a write command;
b) in response to receiving the write command:
i) writing to a temporary working table; and
ii) submitting a corresponding write request to the blockchain for consensus voting; and
c) upon receiving a result of the consensus voting, modifying the query table in accordance with the write command; and otherwise leaving the query table unchanged;
d) upon a new block being synced into the blockchain,
using a blockchain listener service component to retrieve a data change log from content of the new block;
converting the data change log to a corresponding database change command; and
executing the database change command in the database.

10. The method of claim 9, further comprising, prior to said receiving the write command, selecting a first table in the database requiring synchronization with the blockchain and creating said temporary working table corresponding to the first table.

11. The method of claim 10, further comprising importing historical data from the first table into said query table prior to said receiving the write command.

12. A system for synchronizing a database and a blockchain, the system comprising a processor executing instructions stored in memory so that, upon receiving a write request comprising data to be written to the database being received from an application, the processor performs the steps of:
a) writing the data into a working table in the database;
b) submiting a data operation record to the blockchain for consensus voting; and
c) writing the data into a query table in the database upon receiving indication of a successful result for the consensus voting, and otherwise leaving the query table unchanged;
d) upon a new block being synced into the blockchain,
using a blockchain listener service component to retrieve a data change log from content of the new block;
converting the data change log to a corresponding database change command; and
executing the database change command in the database.

13. The system of claim 12, wherein writing the data into the working table comprises setting a status field in the working table to one of a set of predetermined values.

14. The system of claim 13, wherein the set of predetermined values comprise “confirmed”, insert pending”, “update pending” and “delete pending”.

15. The system of claim 12, wherein the instructions further comprise a database proxy causing the processor to:
a) intercept the write request targeting the query table from the application;
b) parse the write request to compose the data operation record and a corresponding statement to modify the database; and
c) modify the working table using the statement.

16. The system of claim 15, wherein the database is a relational database management system (RDBMS) and the statement is a structured query language (SQL).

17. The system of claim 16, wherein the instructions further comprise a blockchain listener component, causing the processor to:
a) retrieve new data in response to a new block in the blockchain;
b) generate a dataset associated with the new data, the dataset comprising an SQL statement; and
c) execute the SQL statement in the database to modify the query table in accordance with the new data.

18. The system of claim 17, wherein the dataset comprises one or more of: a table name; a primary key; an original record value before modification; modified new record value; data operation type; and database node number of operation.

19. The system of claim 12, wherein upon receiving a read command, the processor reads data from the query table.

20. The system of claim 12, wherein said writing the data into said working table in the database, the instructions further cause the processor to:
generate a dataset comprising one or more of a table name; a primary key; an original record value before modification; modified new record value; data operation type; and database node number of operation.

21. A system for augmenting a first application using a first database with consensus voting in a blockchain, the first application running on a first node on the blockchain, the system comprising:
a) a first database proxy receiving application commands from the first application and translating them into database commands;
b) a first set of temporary tables in the first database for storing local transactions before the blockchain completes the consensus voting;
c) a first set of query tables for recording data after the blockchain returns result of the consensus voting;
d) a first database log tracking module to track the changes in the first database;
e) a first blockchain writer module to write data to the blockchain; and
f) a first blockchain listener module to monitor events and changes in the blockchain
the first blockchain listener module and the first blockchain writer module in communication with the blockchain, the first database proxy in communication with the first application and the first database, and the first blockchain listener module in communication with the first database
wherein upon a new block being synced into the blockchain,
using the blockchain listener service component to retrieve a data change log from content of the new block;
converting the data change log to a corresponding database change command; and
executing the database change command in the database.

22. The system of claim 21, wherein the blockchain comprises a second node running a second application using a second database, the system further comprising:
a) a second database proxy receiving application commands from the second application and translating them into database commands;
b) a second set of temporary tables in the second database for storing local transactions before the blockchain completes the consensus voting;
c) a second set of query tables for recording data after the blockchain returns result of the consensus voting;
d) a second database log tracking module to track the changes in the second database;
e) a second blockchain writer module to write data to the blockchain; and
f) a second blockchain listener module to monitor events and changes in the blockchain
the second blockchain listener module and the second blockchain writer module in communication with the second blockchain, the second database proxy in communication with the second application and the second database, and the second blockchain listener module in communication with the second database.
